(19) United States
(12) Patent Application Publication
(10) Pub. No.: US 2007/0012527 A1
(43) Pub. Date: Jan. 18, 2007

(54) Brake system for remote-control toy car

(75) Inventor: Chao-Chuan Wu, Taipei City (TW)

Correspondence Address: BIRCH STEWART KOLASCH & BIRCH, PO BOX 747, FALLS CHURCH, VA, 22040-0747, US

(73) Assignee: Hong Nor Enterprise Co., Ltd.

(21) Appl. No.: 11/435,738

(22) Filed: May 18, 2006

(30) Foreign Application Priority Data
Jul. 12, 2005 (TW) 094211847

(51) Int. Cl. F16D 55/36

(52) U.S. Cl. 188/71.5; 188/72.7

(57) ABSTRACT

A brake system used in a remote-control toy car is disclosed to include brake pads and brake discs alternatively arranged on two holder members at two sides of a differential, two shafts respectively pivotally mounted in the two holder members and deviated from one side of the center line, each shaft having an eccentrically arranged actuating blocks, and two brake rods for pulling by an external pull force to bias the shafts and to force the eccentrically arranged actuating blocks of shafts against the brake discs and brake pads evenly so as to stop the remote-control toy car efficiently.

### BACKGROUND OF THE INVENTION

1. Field of the Invention

The present invention relates to remote-control toy car and more specifically, to a brake system for remote-control toy car, which keeps the respective brake discs evenly rubbed against the respective brake pads, thereby achieving a high performance and prolonging the work life of the parts.

2. Description of the Related Art

The brake system of a conventional remote-control toy car, as shown in FIG. 5, comprises a differential 10, two substantially U-shaped holder members 60 fixedly provided at two sides of the differential 10, each holder member 60 having two parallel upright posts 61 and a vertical bottom axle hole 62 equally spaced between the upright posts 61, a plurality of brake pads 32 respectively and symmetrically fastened to the holder members 60 at two sides of the differential 10 with screws 31, a plurality of brake discs 30 respectively and symmetrically provided at two sides of the differential 10 and respectively separated from one another by the brake pads 32, two shafts 70 respectively supported on the holder members 60, each shaft 70 having a shaft body 71 rotatably mounted in the vertical bottom axle hole 62 of the associating holder member 60 and an actuating block 72, two brake rods 73 respectively connected to the shafts 70, a plate member 80 suspending above the differential 10, the plate member 80 having two middle through holes 81 at two distal ends and two pairs of mounting holes 82 respectively disposed at two sides of each of the middle through holes 81 and respectively fastened to the upright posts 61 of the holder members 60 with screws 84, and two axle bushes 83 respectively mounted in the middle through holes 81 of the plate member 80 to support the respective top ends of the shaft bodies 71 of the shafts 70.

Referring to FIGS. 5-7, when pulling the pull rods 73, the shafts 70 are rotated in the vertical bottom axle holes 62 of the associating holder members 60 through an angle to force the actuating blocks 72 against the respective brake discs 30 and the respective brake pads 32, thereby stopping the remote-control toy car.

According to the aforesaid brake system, the actuating block 72 is symmetrically fastened to the associating shaft body 71 and the shaft body 71 is mounted in the vertical bottom axle hole 62 of the associating holder member 60 corresponding to the center line L2 of the brake discs 30. When biasing the shafts 70, the actuating blocks 72 of the shafts 70 are stopped at the brake discs 30 against the brake pads 32 at a location beyond the centerline L2, therefore each brake disc 30 has one lateral side closely stopped against the associating brake pad 32. However, a gap S is left at the opposite lateral side between each brake disc 30 and the associating brake pad 32. Because of uneven friction between each brake disc 30 and the associating brake pad 32, the braking force is low, and the brake discs 30 and brake pads 32 of the brake system wear quickly with use.

### SUMMARY OF THE INVENTION

The present invention has been accomplished to provide a brake system for remote-control toy car, which eliminates the aforesaid problem.

According to the present invention, the brake system comprises a differential; two substantially U-shaped holder members fixedly provided at two sides of said differential, said holder member having a vertical bottom axle hole and two parallel upright posts at two sides of said vertical bottom axle hole; a plurality of brake pads and a plurality of brake discs symmetrically and alternatively arranged at two sides of said differential; two shafts respectively supported on said holder members, said shafts each having a shaft body rotatably mounted in the vertical bottom axle hole of the associating holder member and an actuating block fixedly fastened to said shaft body; and two brake rods respectively coupled to the shaft bodies of said shafts for pulling by a pulling force to bias said shafts and to force the actuating blocks of said shafts against said brake discs and said brake pads, wherein the vertical bottom axle hole of each of said holder members is spaced from the mid point between the two upright posts of the respective holder member disposed near one upright post of the respective holder member and not in line with the mid point of each of said brake discs and said brake pads; the actuating block of each of said shafts is eccentrically affixed to the associating shaft body.

### BRIEF DESCRIPTION OF THE DRAWINGS

FIG. 1 is an exploded view of a brake system for remote-control toy car according to the present invention.

FIG. 2 is an assembly end view of the brake system for remote-control toy car according to the present invention.

FIG. 3 is a top view of a part of the brake system for remote-control toy car according to the present invention.

FIG. 4 corresponds to FIG. 3 showing the braking action of the brake system.

FIG. 5 is an exploded view of a brake system for remote-control toy car according to the prior art.

FIG. 6 is a top view of a part of the brake system for remote-control toy car according to the prior art.

FIG. 7 corresponds to FIG. 6 showing the braking action of the brake system.

### DETAILED DESCRIPTION OF THE PREFERRED EMBODIMENT

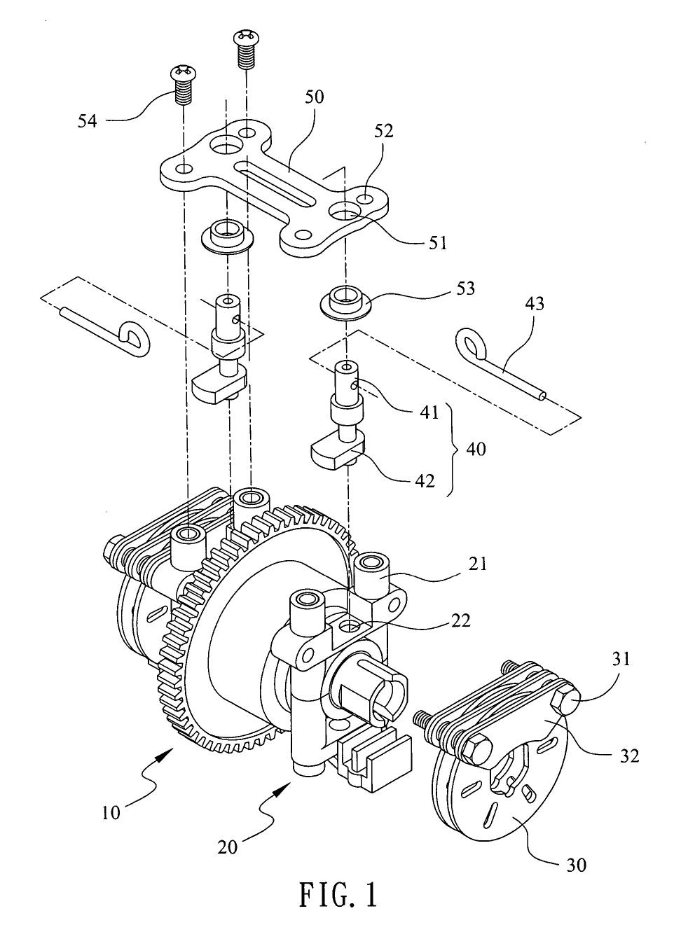

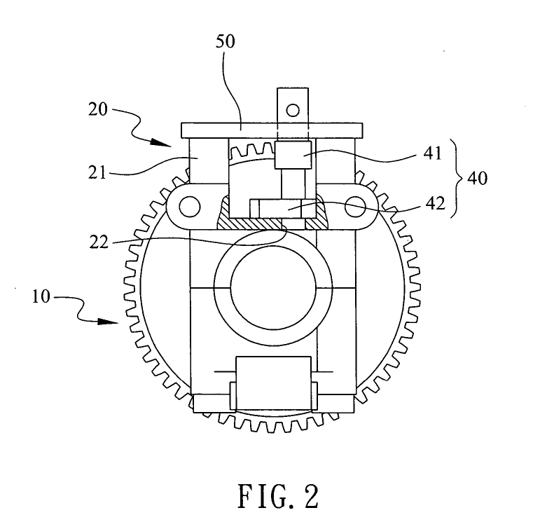

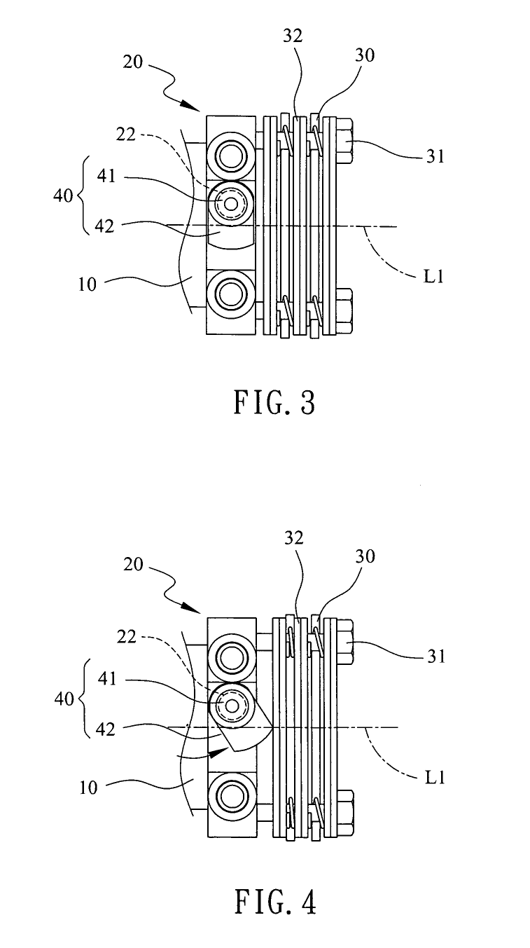

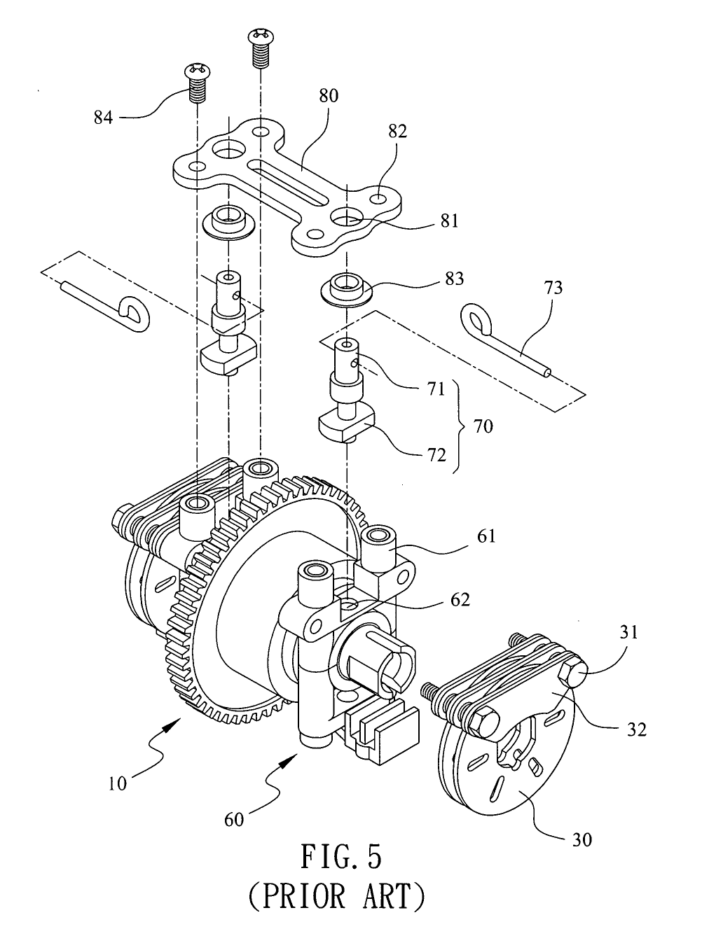

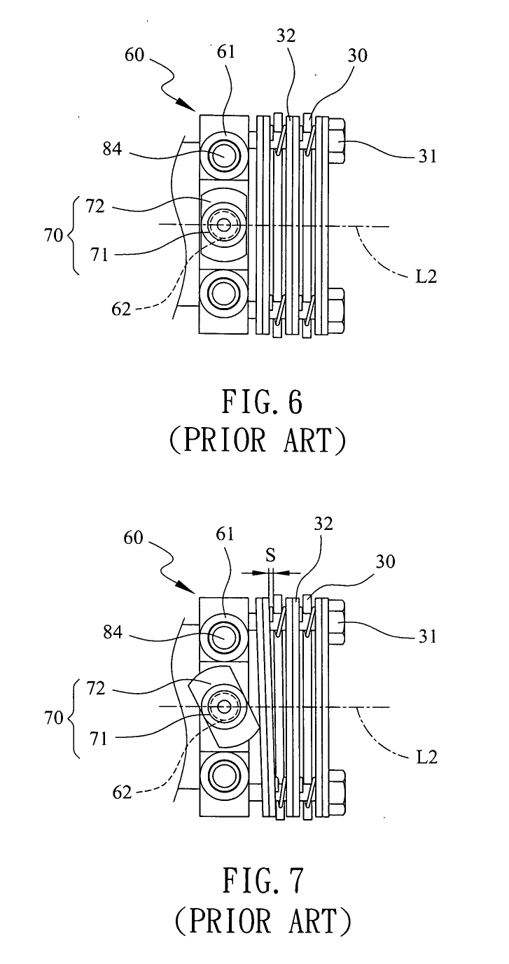

Referring to FIGS. 1-3, a brake system used in a remote-control toy car in accordance with the present invention is shown comprising a differential 10, two substantially U-shaped (or H-shaped) holder members 20 fixedly provided at two sides of the differential 10, each holder member 20 having two parallel upright posts 21 and a vertical bottom axle hole 22 spaced between the upright posts 21 at a location away from the mid point between the upright ports 21 and near one upright post 21, a plurality of brake pads 32 respectively and symmetrically fastened to the holder members 20 at two sides of the differential 10 with screws 31, a plurality of brake discs 30 respectively and symmetrically provided at two sides of the differential 10 and respectively separated from one another by the brake pads 32, two shafts 40 respectively supported on the holder members 20, each shaft 40 having a shaft body 41 rotatably mounted in the vertical bottom axle hole 22 of the associating holder member 20 and an actuating block 42 eccentrically fastened to the shaft body 41, two brake rods 43 respectively connected to the shafts 40, a plate member 50 suspending above the differential 10. The plate member 40 has two middle through holes 51 at two distal ends and two pairs of mounting holes 52 respectively disposed at two sides of each of the middle through holes 51. The mounting holes 52 of the plate member 50 are respectively fastened to the upright posts 21 of the holder members 20 with screws 54. Further, two axle bushes 53 are respectively sleeved onto the shaft bodies 41 of the shafts 40 and respectively mounted in the middle through holes 51 of the plate member 50 to support the shafts 40 in the holder members 20.

Referring to FIG. 4 and FIGS. 1˜3 again, when pulling the pull rods 43, the shafts 40 are rotated in the vertical bottom axle holes 32 of the associating holder members 30 through an angle to force the actuating blocks 42 against the respective brake discs 30 and the respective brake pads 32, thereby stopping the remote-control toy car.

According to the present invention, the actuating block 42 is eccentrically fastened to the associating shaft body 41 and the shaft body 41 is mounted in the vertical bottom axle hole 22 of the associating holder member 20 corresponding to the center line L1 of the brake discs 30. When biasing the shafts 40, the actuating blocks 42 of the shafts 40 are stopped at the brake discs 30 against the brake pads 32 at a location corresponding to the center line L2, therefore each brake disc 30 is closely and evenly stopped against the associating brake pad 32, achieving a high braking performance. Because of even friction between each brake disc 30 and the associating brake pad 32, the braking force is high, and the brake discs 30 and brake pads 32 of the brake system do not wear quickly with use.

Although a particular embodiment of the invention has been described in detail for purposes of illustration, various modifications and enhancements may be made without departing from the spirit and scope of the invention.

What the invention claimed is:

1. A brake system used in a remote-control toy car, comprising:
a differential;
two substantially U-shaped holder members fixedly provided at two sides of said differential, said holder member having a vertical bottom axle hole and two parallel upright posts at two sides of said vertical bottom axle hole;
a plurality of brake pads and a plurality of brake discs symmetrically and alternatively arranged at two sides of said differential;
two shafts respectively supported on said holder members, said shafts each having a shaft body rotatably mounted in the vertical bottom axle hole of the associating holder member and an actuating block fixedly fastened to said shaft body; and
two brake rods respectively coupled to the shaft bodies of said shafts for pulling by a pulling force to bias said shafts and to force the actuating blocks of said shafts against said brake discs and said brake pads;
wherein the vertical bottom axle hole of each of said holder members is spaced from the mid point between the two upright posts of the respective holder member disposed near one upright post of the respective holder member and not in line with the mid point of each of said brake discs and said brake pads; the actuating block of each of said shafts is eccentrically affixed to the associating shaft body.

2. The brake system as claimed in claim 1, further comprising a plate member suspending above said differential, said plate member having two middle through holes disposed at two distal ends thereof and two pairs of mounting holes respectively disposed at two sides of each of said middle through holes and respectively fastened to the upright posts of said holder members with screws, and two axle bushes respectively sleeved onto the shaft bodies of said shafts and respectively mounted in the middle through holes of said plate member to support said shafts in said holder members.
